(19) United States
(12) Patent Application Publication
(10) Pub. No.: US 2017/0057327 A1
(43) Pub. Date: Mar. 2, 2017

(54) THIN REGISTER

(71) Applicant: Howa Plastics Co., Ltd., Toyota-shi (JP)

(72) Inventors: Akihiro SHIBATA, Okazaki-shi (JP); Hidekazu MAKIMURA, Toyota-shi (JP); Yosuke MATSUZAWA, Toyotai-shi (JP)

(73) Assignee: Howa Plastics Co., Ltd., Toyota-shi (JP)

(21) Appl. No.: 15/155,212

(22) Filed: May 16, 2016

(30) Foreign Application Priority Data
Aug. 25, 2015 (JP) 2015-166058

(51) Int. Cl. B60H 1/34; B60H 1/00

(52) U.S. Cl. CPC B60H 1/3421; B60H 1/0065

(57) ABSTRACT

A front fin of a front movable louver is axially supported immediately inside of an air outlet, and an auxiliary fin is axially supported in a recessed portion under the front fin. The front fin and the auxiliary fin are joined via a link member, and opposite side end portions at an upstream side of the auxiliary fin are axially supported via pivots. An inclined surface is provided on a distal end portion at a downstream side of the auxiliary fin. A recessed portion cover to overlay the recessed portion is attached to the recessed portion. When the front movable louver is operated so as to turn, the auxiliary fin turns so as to project its distal end portion upward through an opening in a front portion of the recessed portion cover and make the inclined surface of its distal end portion hit against an air flow flowing under the front fin.

### BACKGROUND OF THE INVENTION

1. Field of the Invention

The present invention relates to a register to be used for air blow adjustment of an air conditioner of an automobile, etc., and specifically, to a thin register having an air outlet that is vertically short and horizontally narrow and long.

2. Description of Related Art

As registers for air blow adjustment to be mounted on instrument panels or the like of automobiles, thin registers having air outlets that are vertically short and horizontally narrow and long have conventionally been known in JP2013-116650 A, etc.

This register is constituted with a forwardly narrowing shape as a shape in terms of the vertical width of a bezel to be fitted to a front portion of a retainer, with an air outlet that is vertically short and horizontally narrow and long being provided at the front of the bezel, and with a front movable louver being disposed immediately inside of the air outlet. In the center of the front movable louver, a central horizontal fin is arranged in the horizontal direction, and an upper auxiliary horizontal fin and a lower auxiliary horizontal fin are arranged substantially in parallel above and below the central horizontal fin, respectively, and these horizontal fins are joined by a link bar to provide a structure that the respective horizontal fins are oriented in the same direction in conjunction with each other when the front movable louver is operated so as to be turned upward or downward.

However, the above-described thin register has had a problem that, when the front movable louver is turned, for example, to the upside, the central horizontal fin, the upper auxiliary horizontal fin, and the lower auxiliary horizontal fin all turn obliquely upward, but because the air outlet is in a vertically narrowed thin shape, the air blowing direction is unlikely to be oriented to the upside, and the directionality of air blowing is likely to deteriorate.

Also, the thin register is formed in a so-called slanted shape as its front shape to incline so as to retract its upper portion to the upstream side and project its lower portion to the downstream side, and the shape of an instrumental panel on which the register is installed is curved so that it bulges forward under and in front of the air outlet of the register.

Therefore, in the bulging curved portion under and in front of the register, a sticking phenomenon of wind is likely to occur, and when the sticking phenomenon of wind occurs, an air flow blown from the air outlet along the front movable louver is guided to the downside, and the directionality of air blowing to the upside is likely to deteriorate.

Further, although the air outlet of the thin register is vertically narrowed thin, when the front movable louver is brought into a neutral state or turned to the upside, it reaches a state in which peeping into the air outlet from the front of the register is easy. Therefore, there has been a problem that a bottom portion in the retainer hollowed out in a recessed shape is easily viewed between the horizontal fins, which is likely to deteriorate the appearance.

### SUMMARY OF THE INVENTION

It is an object of the present invention to provide a thin register capable of preventing deterioration in appearance and improving the directionality of wind when the front movable louver is turned to the upside.

The object of the present invention can be achieved by a thin register constituted as follows.

That is, a register according to the present invention is a thin register including a register main body having inside an air passage and having in a front portion an air outlet in a horizontally narrow and long shape, and a front movable louver disposed, inside of the air outlet, so as to be able to be turned up or down, and is constituted such that the air outlet is formed in a narrow and long shape by vertically narrowing a downstream-side end portion of the air passage, in a bottom portion immediately inside of the air outlet of the register main body, a recessed portion is formed, the front movable louver is composed of a front fin axially supported immediately inside of the air outlet and an auxiliary fin axially supported in the recessed portion under the front fin, the front fin and the auxiliary fin are joined via a link member, and opposite end portions at an upstream side of the auxiliary fin are axially supported via pivots, an inclined surface is provided on a distal end portion at a downstream side of the auxiliary fin, a recessed portion cover to overlay the recessed portion is attached to the recessed portion, and an opening to project the distal end portion of the auxiliary fin therethrough is provided, in a vicinity of a downstream-side end portion of the recessed portion cover, along a longitudinal direction of the auxiliary fin, and when the front movable louver is operated so as to turn to the upside, the auxiliary fin turns so as to project the distal end portion upward through the opening of the recessed portion cover and make the inclined surface of the distal end portion hit against an air flow flowing under the front fin.

According to this invention, when the front movable louver is brought into a neutral state to use the register, the auxiliary fin can be located inside of the recessed portion cover, which allows performing air blowing in the forward direction of the air outlet with less pressure loss. When the front movable louver is operated so as to turn to the upside, the distal end portion of the auxiliary fin projects into a passage through the opening of the recessed portion cover and acts so as to make the inclined surface of the distal end portion hit against an air flow and bend the air flow upward, which therefore allows blowing air obliquely upward and forward with excellent directionality.

Also, because the recessed portion cover to cover the recessed portion in a bottom portion inside of the air outlet is provided, even in the case of peeping into the air outlet from the front, a bottom portion of the passage hollowed out in a recessed shape is not visible, which allows an improvement in appearance.

Here, the above-described thin register may be constituted such that the air outlet of the register main body is formed, in terms of its front shape, to incline so as to retract an upper portion to the upstream side and project a lower portion to the downstream side. When the thin register is made into a slanted shape as its front shape to incline so as to retract an upper portion to the upstream side and project a lower portion to the downstream side, an air flow blown out from the air outlet is likely to flow along the surface of a bulging portion in front of and under the outlet due to the Coanda effect produced therein, but the register of the present invention can prevent the Coanda effect and blow an air flow oriented forward or upward with satisfactory directionality.

Also, here, the above-described thin register may be constituted such that a recessed groove is longitudinally formed adjacently to the inclined surface of the auxiliary fin, the downstream-side end portion of the recessed portion cover is formed so as to be able to relatively enter into the recessed groove with a turn of the auxiliary fin, and at the time of a turning operation of the front movable louver, when the auxiliary fin turns so as to project the distal end portion into a passage, the downstream-side end portion of the recessed portion cover relatively enters into the recessed groove.

According thereto, when the distal end portion of the auxiliary fin projects into the passage or is returned into the recessed portion, the opening is satisfactorily closed by the distal end portion of the auxiliary fin, and a bottom portion of the passage hollowed out in a recessed shape is not visible, which allows a further improvement in appearance.

Also, here, the above-described thin register may be constituted such that a rear movable louver is disposed on an upstream side of the front movable louver, and on an upstream side of the recessed portion cover, a bearing cover provided with a bearing portion to axially support a rear fin of the rear movable louver is disposed in a manner of covering an upstream side of the recessed portion.

Also, here, the above-described thin register may be constituted such that the auxiliary fin is formed having a fin main body that covers substantially the whole of the opening, and is provided on opposite sides of the fin main body with pivots via lever portions.

Also, here, the above-described thin register may be constituted such that the auxiliary fin is formed with a cover portion provided at front and/or rear (an upstream side and/or downstream side) of the fin main body so as to project therefrom, and constituted so as to cover the opening by the fin main body and the cover portion.

Also, here, the above-described thin register may be constituted such that, at a front surface of the air outlet of the register main body, an outer bezel is attached so as to cover an upper and lower part of the air outlet.

### BRIEF DESCRIPTION OF THE DRAWINGS

FIG. 1 is a front view of a thin register according to an embodiment of the present invention.

FIG. 2 is a left side view of the same register.

FIG. 3 is a sectional view taken along III-III in FIG. 1.

FIG. 4 is a sectional view taken along IV-IV in FIG. 1.

FIG. 5 is a perspective view of the same register.

FIG. 6 is an exploded perspective view of a retainer, a rear movable louver, and a front movable louver of the same register.

FIG. 7 is an exploded perspective view of a bezel and an outer bezel.

FIG. 8 is a perspective view of the front movable louver as viewed from its front side.

FIG. 9 is a perspective view of the front movable louver as viewed from its back side.

FIG. 10 is a left side view of the front movable louver.

FIG. 11 is a perspective view of a front fin and an auxiliary fin of the front movable louver.

FIG. 12 is a left side view of the front fin and the auxiliary fin of the front movable louver.

FIG. 13 is a perspective view of the auxiliary fin.

FIG. 14 is a longitudinal sectional view when the front movable louver is turned up during blowing.

FIG. 15 is a longitudinal sectional view of a thin register of another embodiment.

FIG. 16 is a longitudinal sectional view of a thin register provided with an auxiliary fin of another embodiment.

FIG. 17 is a longitudinal sectional view of a thin register provided with an auxiliary fin of another embodiment.

FIG. 18 is a longitudinal sectional view of a thin register provided with an auxiliary fin of another embodiment.

FIG. 19 is a longitudinal sectional view of a thin register provided with an auxiliary fin of another embodiment.

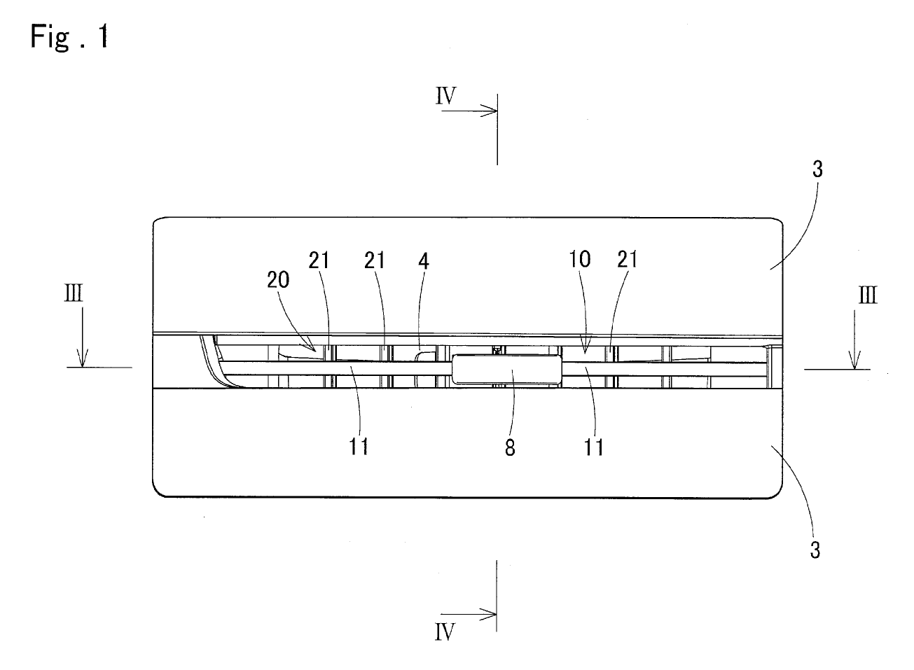

### DESCRIPTION OF THE PREFERRED EMBODIMENTS

Hereinafter, the present invention will be described based on embodiments shown in the drawings. However, the present invention is by no means limited to the embodiments. Any modifications within the requirements of the claims or equivalents relating to the requirements should be included in the scope of the claims.

The thin register is constituted with a retainer 1 having inside an air passage 9 being formed in a vertically thin and flat duct shape, at the front of the retainer 1, a bezel 2 formed with an air outlet 4 in a narrow and long slit shape being attached, with a front movable louver 10 being disposed inside of an air outlet 4, and with a rear movable louver 20 being disposed in an air passage 9 that is on an upstream side of the front movable louver 10. The above-described register main body is composed of the retainer 1 and the bezel 2.

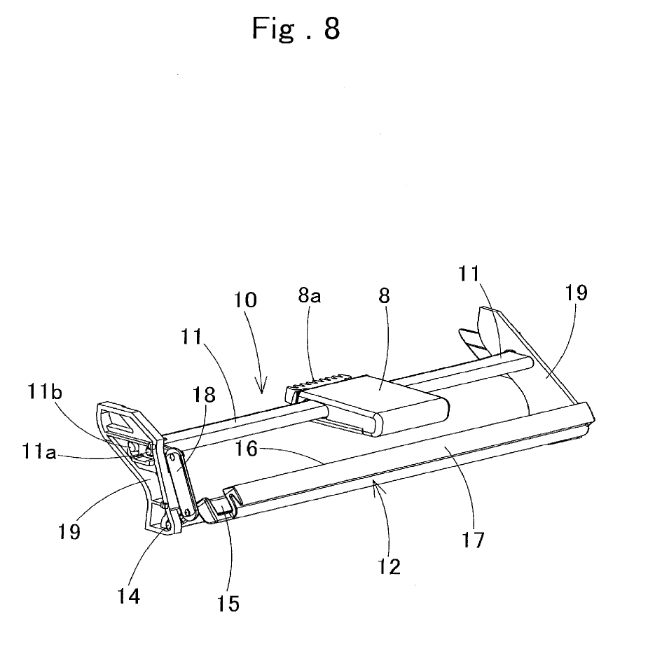

The front movable louver 10, as shown in FIG. 8, etc., includes a single front fin 11 and a single auxiliary fin 12 arranged under the front fin 11, and in the rear movable louver 20 on an upstream side of the front movable louver 10, a plurality of rear fins 21 are juxtaposed in a direction orthogonal to the front movable louver 10 (vertically). The single front fin 11 is disposed, at substantially a center position in the air passage 9 of the retainer 1, longitudinally, immediately inside of the air outlet 4.

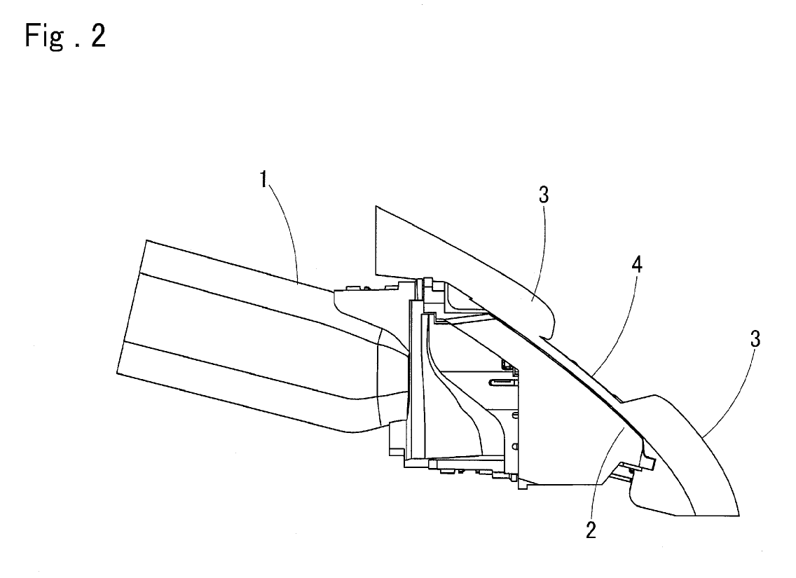

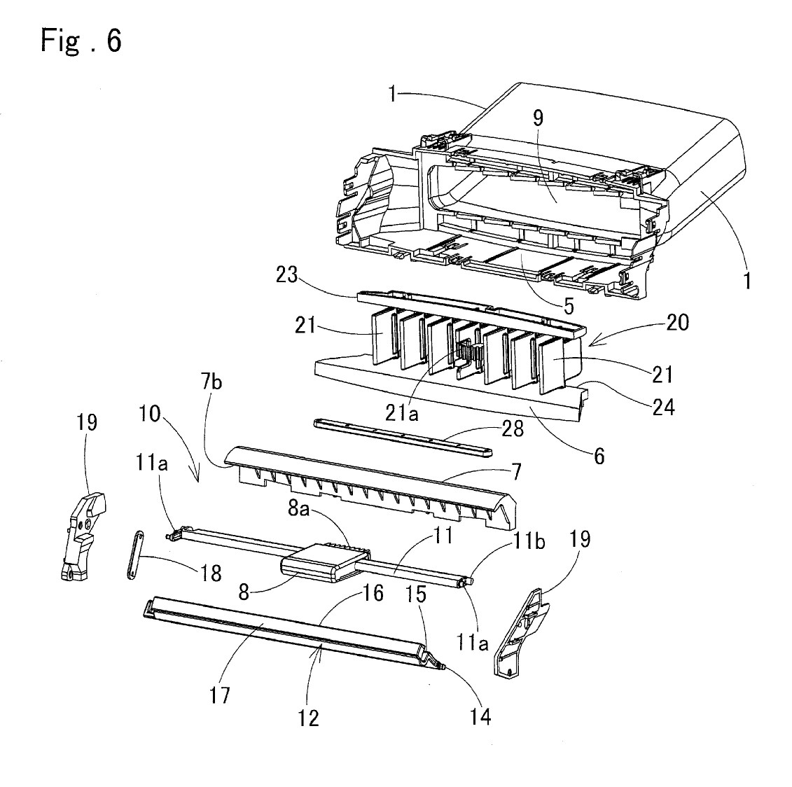

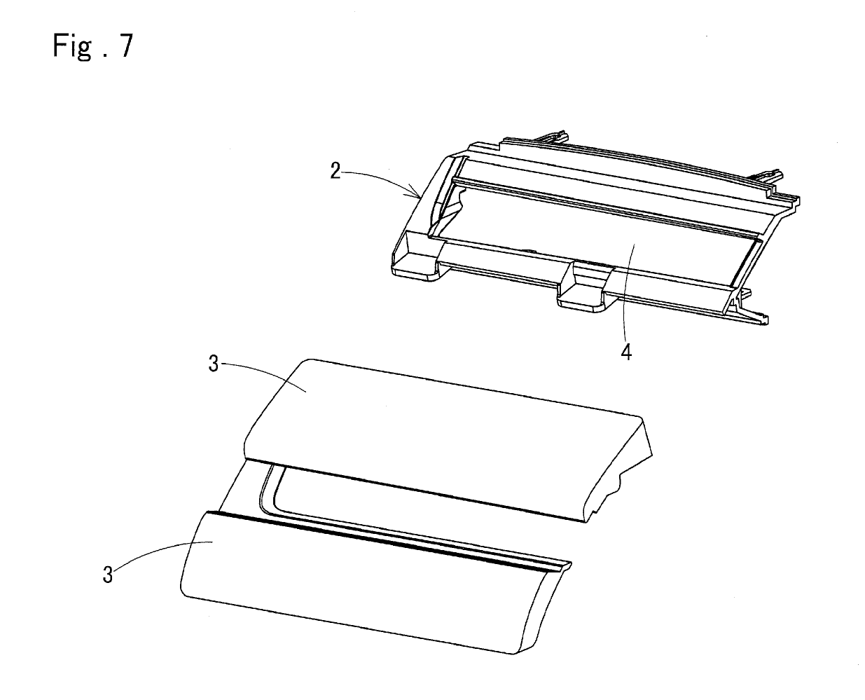

A front portion of the thin register is, as shown in FIG. 2, etc., formed in a slanted manner, and the thin register is formed with its front surface greatly inclined so as to retract an upper portion to the upstream side and project a lower portion to the downstream side. Therefore, a front portion of the retainer 1 and the bezel 2 is, as shown in FIG. 6 and FIG. 7, formed to incline so as to retract its upper portion to the upstream side and project its lower portion to the downstream side, and further, at the front portion of the bezel 2, an outer bezel 3 is attached to incline so as to cover the front portion of the bezel 2.

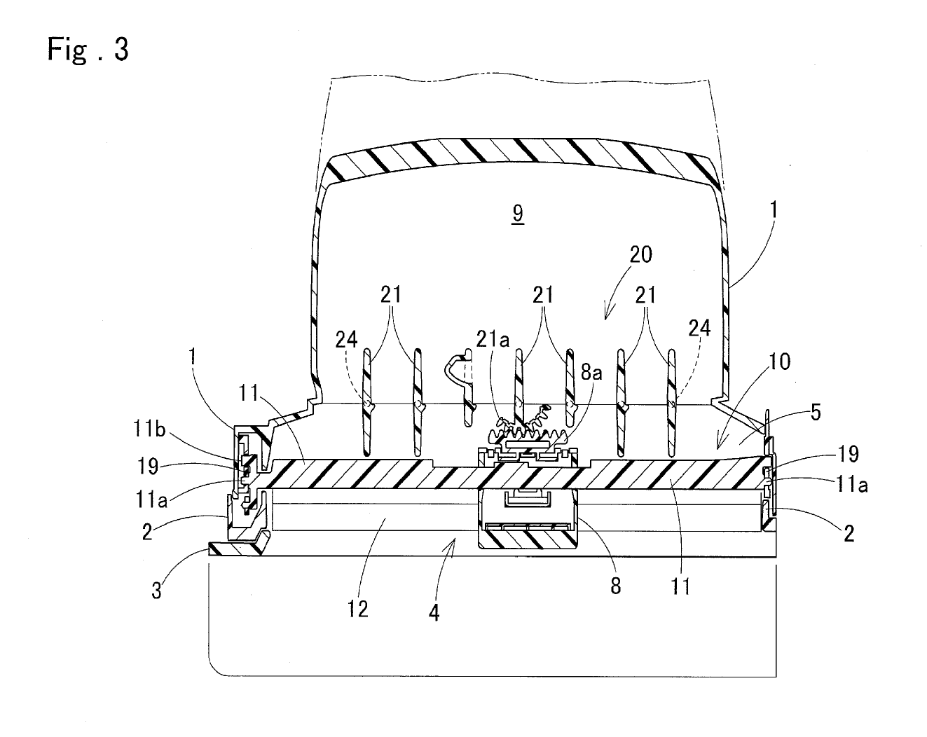

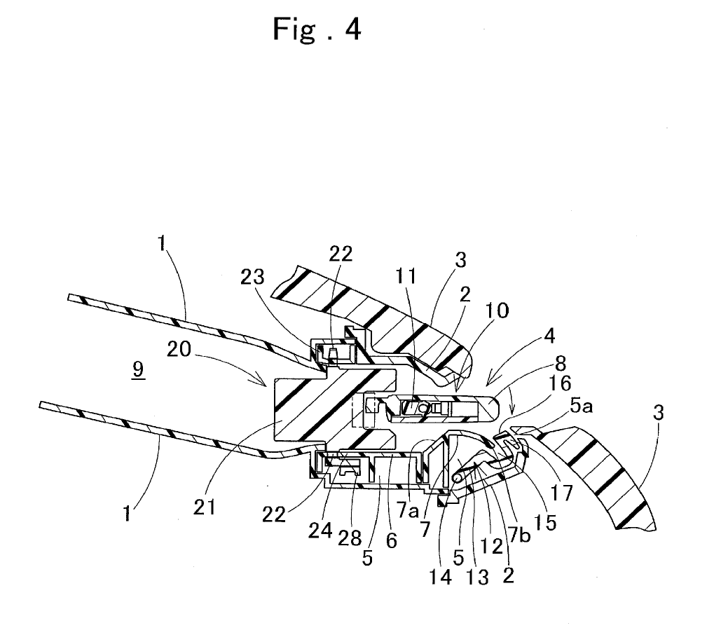

Also, the bezel 2 to be fitted to a front portion of the retainer 1 is, as shown in FIG. 3 and FIG. 4, formed in a shape that its interior has a sectional area considerably enlarged from that of the air passage 9 in the retainer 1, and in the projecting lower front portion of the retainer 1, as shown in FIG. 4 and FIG. 6, a recessed portion 5 is formed at a position one step lower than a bottom surface of the air passage 9. In the recessed portion 5, a bearing cover 6 having a lower bearing portion 24 of the rear movable louver 20 is attached so as to overlay the recessed portion 5. Further, in the recessed portion 5 and on a downstream side of the bearing cover 6, the auxiliary fin 12 of the front movable louver 10 is disposed, and a recessed portion cover 7 is disposed so as to cover the auxiliary fin 12. The front fin 11 and the auxiliary fin 12 of the front movable louver 10 are linked via a link member 18, turn in conjunction with an upward or downward turning operation of the front movable louver 10, and are structured such that, when turned to the upside, a distal end portion 17 of the auxiliary fin 12 projects through an opening 5a that is on a downstream side of the recessed portion cover 7.

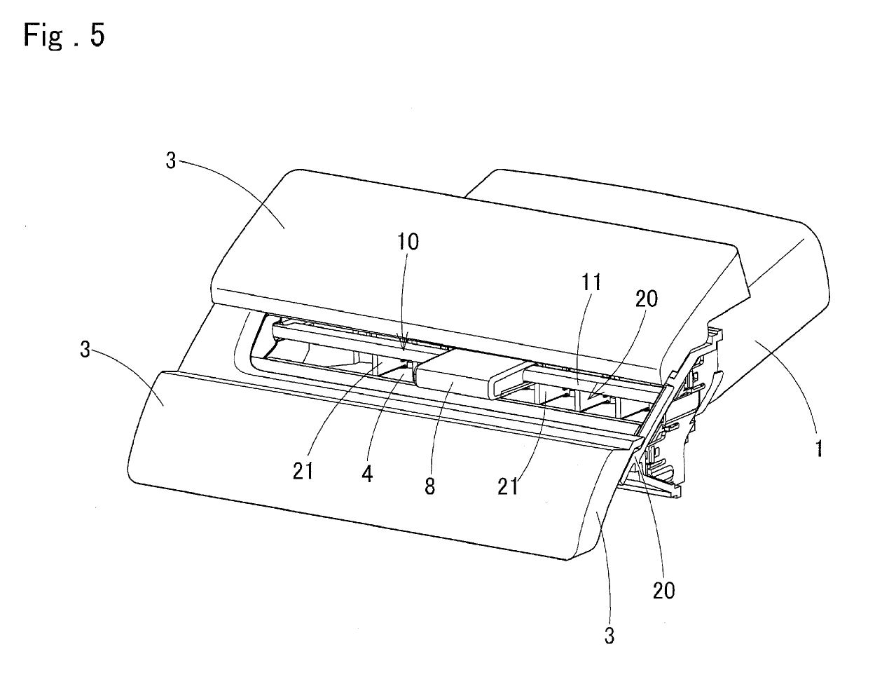

Also, the air outlet 4 formed by an opening in the bezel 2 and the outer bezel 3 at the front of the register is, as shown in FIG. 2 to FIG. 5, formed to incline so as to retract its upper portion rearward at an angle of approximately 60 degrees with respect to a vertical plane in its short-side direction. Further, as shown in FIG. 4, the air outlet 4 is formed narrow and long in a slit shape so as to vertically narrow a cross-sectional shape in a base portion of the bezel 2 and the retainer 1 at a distal end side. Therefore, in a lower portion inside of the air outlet 4, the recessed portion 5 is formed, and the bearing cover 6 and the recessed portion cover 7 are attached in a manner overlaying the same.

As shown in FIG. 4, at an upstream-side part of the bearing cover 6, the lower bearing portion 24 for axially supporting pivots 22 under the respective rear fins 21 of the rear movable louver 20 is provided. Also, in an upstream-side region of the recessed portion cover 7, an obliquely rising inclined surface 7a is provided, and the recessed portion cover 7 acts so as to make an air flow passing under the front fin 11 of the front movable louver 10 hit against its inclined surface 7a to be bent to the upside.

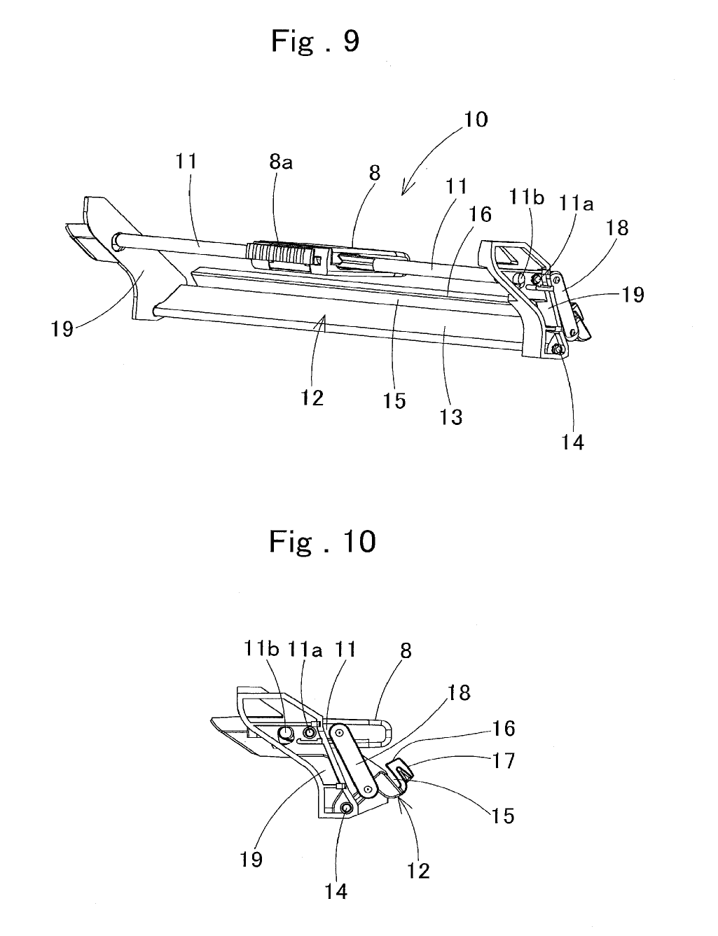

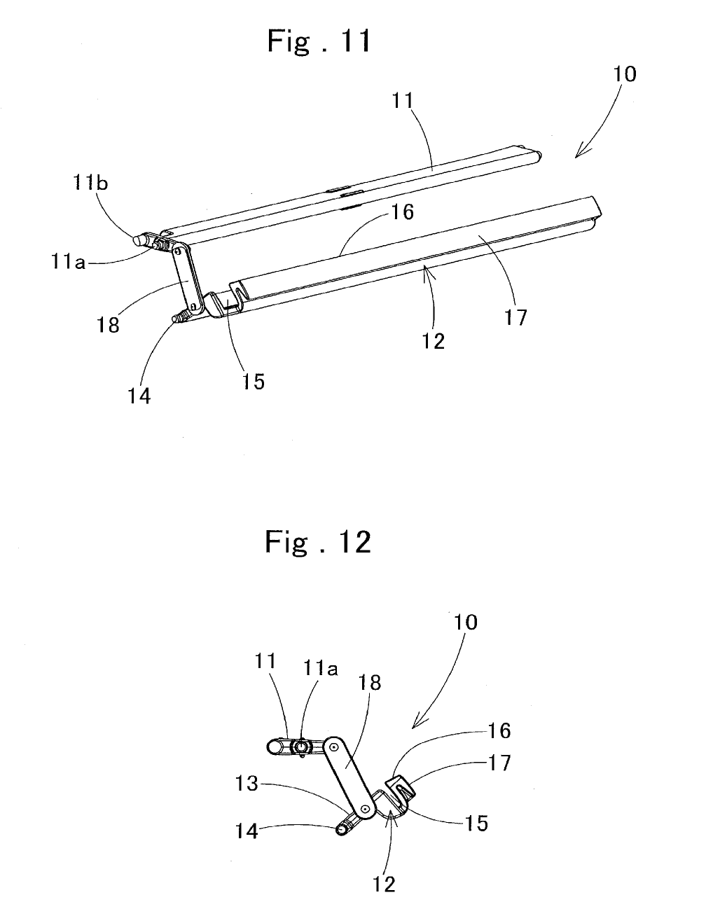

The front movable louver 10 is disposed, immediately inside of the air outlet 4 of the bezel 2, so as to change the wind direction to up or down. As shown in FIG. 3, to right and left side walls of the bezel 2, bearing portions 19 provided on opposite sides of the front movable louver 10 are fitted. The opposite bearing portions 19 are constituted, as shown in FIG. 8 and FIG. 9, so as to axially support the front fin 11 and the auxiliary fin 12 of the front movable louver 10. Pivots 11a are provided so as to project from opposite end portions of the front fin 11 of the front movable louver 10, and pivots 14 are provided so as to project from opposite end portions of the auxiliary fin 12. The projecting pivots 11a and 14 are axially supported so as to be turnable on upper and lower portions of the right and left bearing portions 19. Further, in one end portion of the front fin 11, a guide pin 11b is provided so as to project in parallel to the pivot 11a. The guide pin 11b is fitted with a long hole provided in the bearing portion 19, and limits a turning angle range when the front fin 11 turns to be in a predetermined angle range.

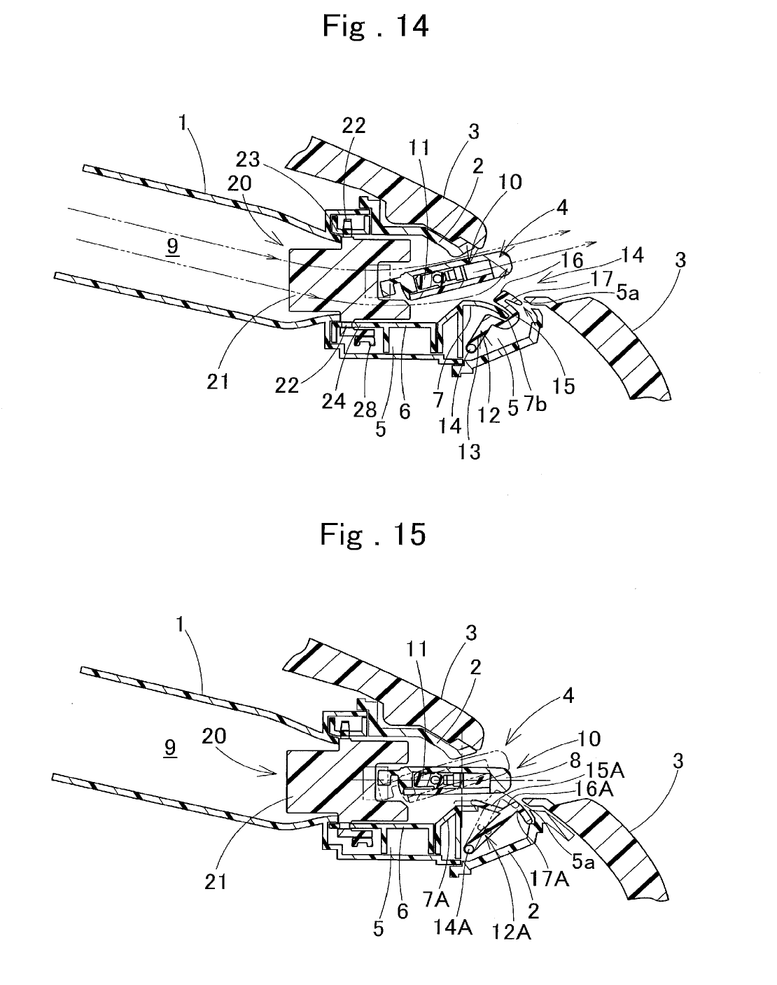

Further, as shown in FIG. 8, in one-end portions of the front fin 11 and the auxiliary fin 12, joint shafts are provided at positions deviated with respect to the pivots, and the link member 18 is linked between the joint shafts of the front fin 11 and the auxiliary fin 12. At the time of an upward or downward turning operation of the front movable louver 10, the front fin 11 and the auxiliary fin 12 are thereby turned in the same direction in conjunction with each other. Specifically, as shown in FIG. 4, when the front fin 11 is brought into a horizontal state, that is, a neutral state, the auxiliary fin 12 is brought into a state of being stored in the recessed portion 5, and as shown in FIG. 14, when the front fin 11 is turned to the upside (turned up), the auxiliary fin 12 turns so as to project the distal end portion 17 including an inclined surface 16 through the opening 5a to the side of a passage thereover.

The auxiliary fin 12 is disposed under the front fin 11, turns similarly to the front fin 11 in conjunction therewith, and operates so as to project the inclined surface 16 at its distal end upward (FIG. 14) when turned to the upside, and at the time of being neutral or when turned to the downside, draw back its distal end portion 17 into the opening 5a as in FIG. 4.

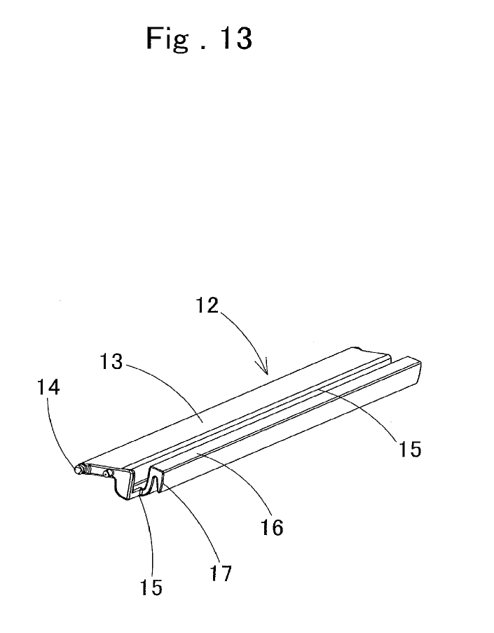

The auxiliary fin 12 is constituted, as shown in FIG. 13, with the pivots 14 being provided on opposite sides of a terminal end portion of its fin main body 13, with the inclined surface 16 provided on an upper surface of the distal end portion 17 of the fin main body 13, and further with a recessed groove 15 provided on the side of an upper surface of the fin main body 13 adjacently to the distal end portion 17 (inclined surface 16). The recessed groove 15 is formed along a longitudinal direction of the fin main body 13 in a shape and size that allows a downstream-side end portion 7b of the recessed portion cover 7 to enter thereinto.

The distal end portion 17 of the auxiliary fin 12 is, as shown in FIG. 4, disposed so as to be located, at its storing position, in the opening 5a produced on the side of the downstream-side end portion 7b of the recessed portion cover 7 covering a downstream side of the recessed portion 5. When the auxiliary fin 12 turns to the upside, as shown in FIG. 14, the inclined surface 16 of the distal end portion 17 of the auxiliary fin 12 projects into the passage thereover, and into the recessed groove 15, the downstream-side end portion 7b of the recessed portion cover 7 enters.

When the front movable louver 10 is brought into a neutral state (the state in FIG. 4 in which the front movable louver 10 is oriented straight in the forward direction), the opening 5a of the recessed portion cover 7 covering the recessed portion 5 is thereby covered, and when the front movable louver 10 is turned to the upside, the inclined surface 16 of the distal end portion 17 of the auxiliary fin 12 is thereby made to project upward. Also, in the neutral state where the auxiliary fin 12 is stored, as shown in FIG. 4, the downstream-side end portion 7b of the recessed portion cover 7 has entered the vicinity of an inlet of the recessed groove 15, which prevents exposure of the opening 5a. The opening 5a for projection of the auxiliary fin 12 is thereby closed also in the neutral state of the front movable louver 10, and even in the case of peeping into the air outlet 4, the interior of the recessed portion 5 further than the opening 5a is not visible, and deterioration in appearance is prevented.

As described above, to a front portion of the retainer 1, the bezel 2 is fitted, and at an upper portion inside of that fitting part, as shown in FIG. 4, an upper bearing portion 23 of the rear movable louver 20 is attached. The rear movable louver 20 is constituted by disposing seven rear fins 21, on an upstream side of the front movable louver 10, in a direction orthogonal to the front movable louver 10. As shown in FIG. 6, the seven rear fins 21 of the rear movable louver 20 are arranged vertically, and juxtaposed at fixed intervals left in the right-left direction. Also, as shown in FIG. 4, the pivots 22 on the respective rear fins 21 are turnably supported by the upper bearing portion 23. The pivots 22 under the respective rear fins 21 are turnably supported by the lower bearing portion 24 provided in the bearing cover 6. Further, the pivots 22 under the rear fins 21 have levers provided perpendicularly to their axes, and the respective levers are joined by a single link bar 28. Further, the respective rear fins 21 turn to the right or left in conjunction with each other according to a sliding operation in the right-left direction of an operation knob 8.

Therefore, at a front portion of the rear fin 21 in the center, as shown in FIG. 3, a sector toothed portion 21a is formed, and with the sector toothed portion 21a, a rack portion 8a provided at a back surface of the operation knob 8 meshes. The operation knob 8 is externally fitted on the front fin 11 so as to be slidable in the right-left longitudinal direction, and by a user grasping the operation knob 8 to operate the front movable louver 10 so as to turn in the up-down direction and sliding the operation knob 8 to the right or left on the front fin 11, the direction of the respective rear fins 21 of the rear movable louver 20 is changed in the right-left direction.

When the thin register constituted as described above is assembled, as shown in FIG. 6, first, the pivots 22 of the respective rear fins 21 of the rear movable louver 20 are fitted into bearing portions of the upper bearing portion 23 and the lower bearing portion 24, the link bar 28 is made to link between the respective rear fins 21 to axially support the same so as to be turnable in conjunction with each other, whereby an assembly of the rear movable louver 20 is assembled.

Next, the upper bearing portion 23 and the lower bearing portion 24 of the rear movable louver assembly are thereafter fitted into the recessed portion 5 formed in the front portion of the retainer 1 to assemble the rear movable louver assembly to the inside of the retainer 1. Next, the front movable louver 10 is assembled as in FIG. 8 to be brought into a front movable louver assembly, and the bearing portions 19 on opposite sides thereof are in this state fitted into the inside of opposite side wall portions in the front portion of the above-described retainer 1. The front movable louver 10 is thereby assembled to the above-described retainer 1. Next, to the front portion of the above-described retainer 1, the bezel 2 and the outer bezel 3 shown in FIG. 7 are fitted, so as to cover the front movable louver 10, by latching of latching portions provided on each other, and the assembly of a thin register is thus completed.

Next, operation of the thin register constituted as described above will be described based on FIG. 4, FIG. 14, etc. The thin register is fitted, for example, in the vicinity of an upper portion of an instrument panel or dashboard inside the cabin of an automobile, by connecting an air inlet at the back side to an air duct (not shown). The outer bezel 3 and the air outlet 4 of the thin register are attached so as to be exposed from a front surface of the instrument panel or dashboard and, in terms of an air blowing direction in the neutral state in FIG. 4, so as to be oriented to an area near the neck of an occupant, for example.

When air blowing is performed in the neutral state of FIG. 4, that is, in a substantially horizontal state of the front movable louver 10, an air flow passed through the air passage 9 flows over and under the front fin 11 of the front movable louver 10, and is blown forward from the air outlet 4 of the bezel 2. At this time, as shown in FIG. 4, the inside of the air outlet 4 is vertically narrowed by the inclined surface 7a of the recessed portion cover 7 and the like to be formed narrow, so that the air flow is blown forward with satisfactory directionality in a state of being vertically compressed thin.

Therefore, even in a state of a lower portion of the outer bezel 3 bulging forward in which the Coanda effect that an air flow intends to flow along its surface is likely to occur, a vertically narrowed air flow can be blown forward with satisfactory directionality.

Also, because the auxiliary fin 12 including the distal end portion 17 has been stored at this time in the recessed portion 5 inside the recessed portion cover 7, pressure loss during air blowing does not increase, which allows efficiently blowing air. Further, with the auxiliary fin 12 stored in the recessed portion 5, its distal end portion 17 closes the opening 5a to make a gap in the opening 5a considerably narrow, so that the interior of the recessed portion 5 is not exposed. Therefore, even when peeping into the inside of the air outlet 4, only the surface of the recessed portion cover 7 and the inclined surface 16 of the auxiliary fin 12 are visible because the downstream-side end portion 7b of the recessed portion cover 7 has relatively entered into the recessed groove 15 of the auxiliary fin 12, which does not cause deterioration in appearance.

On the other hand, when the air blowing direction is changed to upward, the operation knob 8 is grasped to turn the front movable louver 10 to the upside. At this time, the front fin 11 turns (tilts) to the upside as shown in FIG. 14 about its pivots 11a, and simultaneously, the auxiliary fin 12 turns to the upside to project its distal end portion 17 upward through the opening 5a. At this time, the inclined surface 16 on the distal end portion 17 is oriented obliquely to the upside, and acts so as to bend an air flow flowing under the front fin 11 to the side of a lower surface of the front fin 11 (to upward).

That is, the air flow flowing under the front fin 11 hits against the inclined surface 16 of the distal end portion 17 of the auxiliary fin 12 projecting into the passage to be bent to the lower surface side of the front fin 11. The air flow flowing under the front fin 11 is thereby brought into a state of being narrowed further to the upside, and as shown in FIG. 14, is blown with satisfactory directionality, obliquely upward in which the front fin 11 is oriented from the air outlet 4.

Particularly, as in this thin register, when a thin register is formed in a slanted shape as a front shape of the air outlet 4 to incline so as to retract an upper portion to the upstream side and project a lower portion to the downstream side and the outer bezel 3 is attached to an upper and lower part of a front surface of the air outlet 4 in a covering manner, an air flow blown out from the air outlet 4 is likely to flow along the surface of a bulging portion in front of and under the outlet due to the Coanda effect produced therein. However, as shown in FIG. 14, the air flow blown from under the front fin 11 is bent moderately upward by the inclined surface 16 of the auxiliary fin 12, which therefore allows preventing the Coanda effect and blowing air obliquely upward with satisfactory directionality.

Similar to the above-described neutral state, also in a state of the auxiliary fin 12 thus projecting the inclined surface 16, as shown in FIG. 14, the distal end portion 17 of the auxiliary fin 12 has closed the opening 5a and the gap in the opening 5a is considerably narrow, so that the interior of the recessed portion 5 is not exposed. Therefore, even when peeping into the inside of the air outlet 4, only the surface of the recessed portion cover 7 and the inclined surface 16 of the auxiliary fin 12 are visible because the downstream-side end portion 7b of the recessed portion cover 7 has relatively entered into the recessed groove 15 of the auxiliary fin 12, which does not cause deterioration in appearance.

When the air blowing direction is turned to the right or left, the operation knob 8 is made to slide in the right direction or the left direction on the front fin 11. At this time, a horizontal shift of the operation knob 8 makes the rear movable louver 20 turn in the right direction or left direction via the rack portion 8a and the sector toothed portion 21a (FIG. 3), so that the respective rear fins 21 of the rear movable louver 20 are oriented in an obliquely right direction or an obliquely left direction to change the air blowing direction to the right or left.

When the front movable louver 10 is brought into a neutral state to blow air, the auxiliary fin 12 is thus located inside of the recessed portion cover 7, which allows performing air blowing in the forward direction of the air outlet 4 with less pressure loss. Also, when the front movable louver 10 is operated so as to turn to the upside, the distal end portion 17 of the auxiliary fin 12 projects into a passage through the opening 5a of the recessed portion cover 7 and acts so as to make the inclined surface 16 of the distal end portion 17 hit against an air flow and bend the air flow upward, which therefore allows blowing air obliquely upward and forward with excellent directionality. Further, because the recessed portion cover 7 to cover the recessed portion 5 in a bottom portion inside of the air outlet 4 is provided, even in the case of peeping into the air outlet 4 from the front, a bottom portion of the passage hollowed out in a recessed shape is not visible, which allows an improvement in appearance.

FIG. 15 to FIG. 19 each show a thin register using an auxiliary fin of another embodiment. For the same parts as those of the embodiment described above, the same reference signs as above will be used in the figures and description thereof will be omitted.

The auxiliary fin 12A of the front movable louver 10 shown in FIG. 15 is provided on its distal end portion 17 with an inclined surface 16A, has no recessed groove, and is provided on an upstream side of the distal end portion 17A with a cover portion 15A so as to cover the opening 5a of the recessed portion 5. Also, when the auxiliary fin 12A is turned, the cover portion 15A covers a distal end part of a recessed portion cover 7A and slides. Further, the distal end portion 17A of the auxiliary fin 12A is formed like a cover, and is in a shape to cover the opening 5a of the recessed portion 5 together with the cover portion 15A.

On opposite sides of a base portion of the auxiliary fin 12A, similar to the above, pivots 14A are provided, and axially supported so as to be turnable. Also, a joint shaft is provided in one end portion of the auxiliary fin 12A, and similar to the above, the joint shaft and the front fin 11 are linked by a link member, and the auxiliary fin 12A turns in conjunction with the front fin 11.

When the front movable louver 10 including the auxiliary fin 12A constituted as described above is brought into a neutral state as shown by the solid line in FIG. 15, the auxiliary fin 12A is brought into a state of covering the opening 5a of the recessed portion 5 and also storing its distal end portion 17A in the recessed portion 5. Therefore, the interior of the recessed portion 5 is not exposed, and even when peeping into the inside of the air outlet 4, only the surface of the distal end portion 17A is visible, which does not cause deterioration in appearance. During air blowing, an air flow sent through the air passage 9 passes through a space over and under the front fin 11, and similar to the above, an air flow moderately narrowed vertically is blown with satisfactory directionality in the forward direction.

When the front movable louver 10 is turned up, that is, operated so as to turn to the upside, as shown by the virtual lines in FIG. 15, the auxiliary fin 12A turns to the upside together with the front fin 11, and its inclined surface 16A projects through the opening 5a into the passage thereover to be oriented to the lower surface side of the front fin 11 in an inclined manner. An air flow flowing under the front fin 11 thereby hits against the inclined surface 16A to be bent upward, that is, to the lower surface side of the front fin 11.

The air flow flowing under the front fin 11 is thereby satisfactorily bent to the upside, so that air blowing from the air outlet 4 is blown with satisfactory directionality, obliquely upward in which the front fin 11 is oriented. Also, the opening 5a of the recessed portion 5 is covered at this time with the distal end portion 17A of the auxiliary fin 12A not to be exposed, and even when peeping into the inside of the air outlet 4, only the surface of the distal end portion 17A is visible, which does not cause deterioration in appearance.

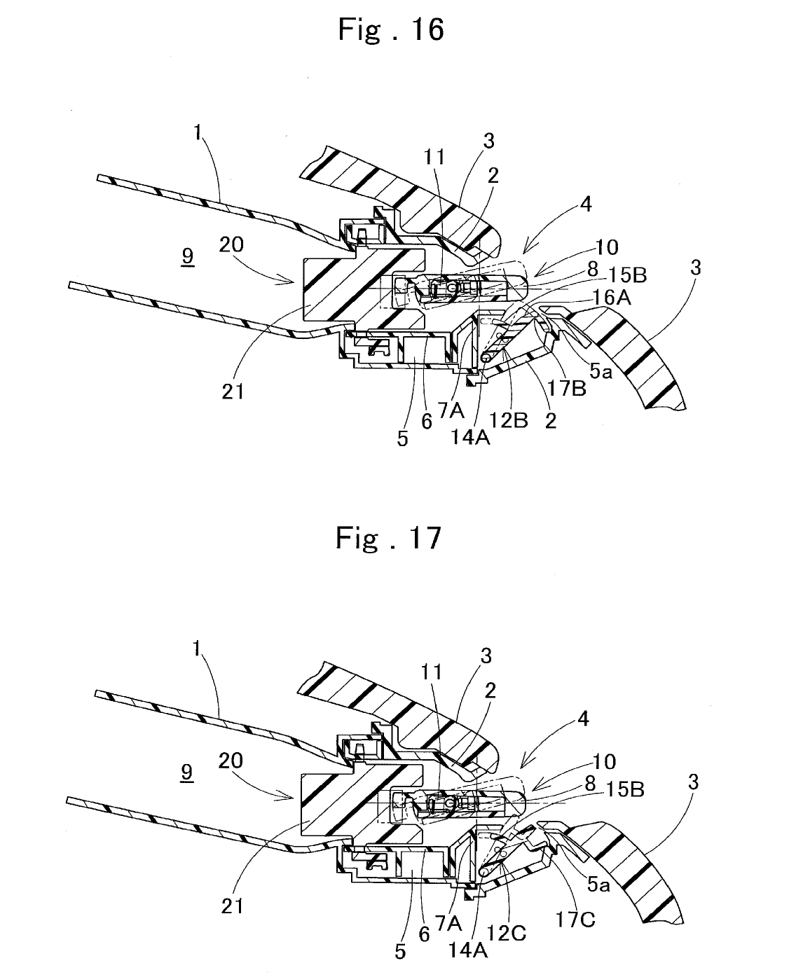

FIG. 16 and FIG. 17 show modified forms of the auxiliary fin constituted as described above. The auxiliary fin 12B in FIG. 16 is constituted such that a cover portion 15B is located inside of the recessed portion cover 7A, and on its distal end portion, the same inclined surface 16A as above is provided, and when the front fin 11 is turned to the upside, the inclined surface 16A is made to project upward to guide air to the upside in air blowing direction. Similar to the above-described auxiliary fin 12A, the auxiliary fin 12B is constituted so as to cover the opening 5a of the recessed portion 5 by the cover portion 15B and the distal end portion 17B. With the auxiliary fin 12B, both in a neutral state and when the same is turned, the distal end portion 17B and the cover portion 15B cover the opening 5a of the recessed portion 5, so that the gap is minimized. Deterioration in appearance accordingly does not occur.

Also, for the auxiliary fin 12C in FIG. 17, at a position one step lower than its distal end portion, a distal end cover portion 17C is provided. The distal end cover portion 17C covers the opening 5a of the recessed portion 5 together with the cover portion 15B to make a bottom portion of the recessed portion 5 less visible, preventing deterioration in appearance.

The auxiliary fin 12D of the front movable louver 10 shown in FIG. 18 is constituted with lever portions 14D being provided in opposite end portions of a fin main body 13D so as to project obliquely downward, and a pivot 14A is provided on a terminal end portion of the lever portion 14D. The auxiliary fin 12D thereby turns in a predetermined angle range about the pivots 14A via the opposite lever portion 14D. For the auxiliary fin 12D, the whole of the fin main body 13D is formed so as to cover the opening 5a of the recessed portion 5, and on a downstream side (front portion) of the fin main body 13D, an inclined surface 16D is provided. Also, similar to the above, when the auxiliary fin 12D is turned, the fin main body 13D covers a distal end part of a recessed portion cover 7D and slides.

Also, a joint shaft is provided on one lever portion 14D of the auxiliary fin 12D, and the joint shaft and the front fin 11 are linked by a link member, and the auxiliary fin 12D turns in conjunction with the front fin 11. Also, as shown in FIG. 18, at a lower surface of the fin main body 13D, a guide pin 15D is provided so as to project therefrom, and the guide pin 15D is engaged with a guide groove provided in the bearing portion 19 of the front movable louver 10, and limits a turning range of the auxiliary fin 12D to a predetermined angle range.

When the front movable louver 10 including the auxiliary fin 12D constituted as described above is brought into a neutral state as shown by the solid line in FIG. 18, the fin main body 13D of the auxiliary fin 12D is brought into a state of covering the opening 5a of the recessed portion 5 and having the inclined surface 16D of its distal end portion 17A stored in the recessed portion 5. Therefore, the interior of the recessed portion 5 is not exposed, and even when peeping into the inside of the air outlet 4, only the surface of the distal end portion is visible, which does not cause deterioration in appearance. During air blowing, an air flow sent through the air passage 9 passes through a space over and under the front fin 11, and similar to the above, an air flow moderately narrowed vertically is blown with satisfactory directionality in the forward direction.

When the front movable louver 10 is turned up, as shown by the virtual lines in FIG. 18, the fin main body 13D of the auxiliary fin 12D turns to the upstream side, and the inclined surface 16D of the distal end portion projects through the opening 5a into the passage thereover to be oriented to the lower surface side of the front fin 11 in an inclined manner. An air flow flowing under the front fin 11 thereby hits against the inclined surface 16D to be bent upward, that is, to the lower surface side of the front fin 11.

The air flow flowing under the front fin 11 is thereby satisfactorily bent to the upside, so that air blowing from the air outlet 4 is blown with satisfactory directionality, obliquely upward in which the front fin 11 is oriented. Also, the opening 5a of the recessed portion 5 is covered at this time with the fin main body 13D of the auxiliary fin 12D not to be exposed, and even when peeping into the inside of the air outlet 4, only the surface of the fin main body 13D is visible, which does not cause deterioration in appearance.

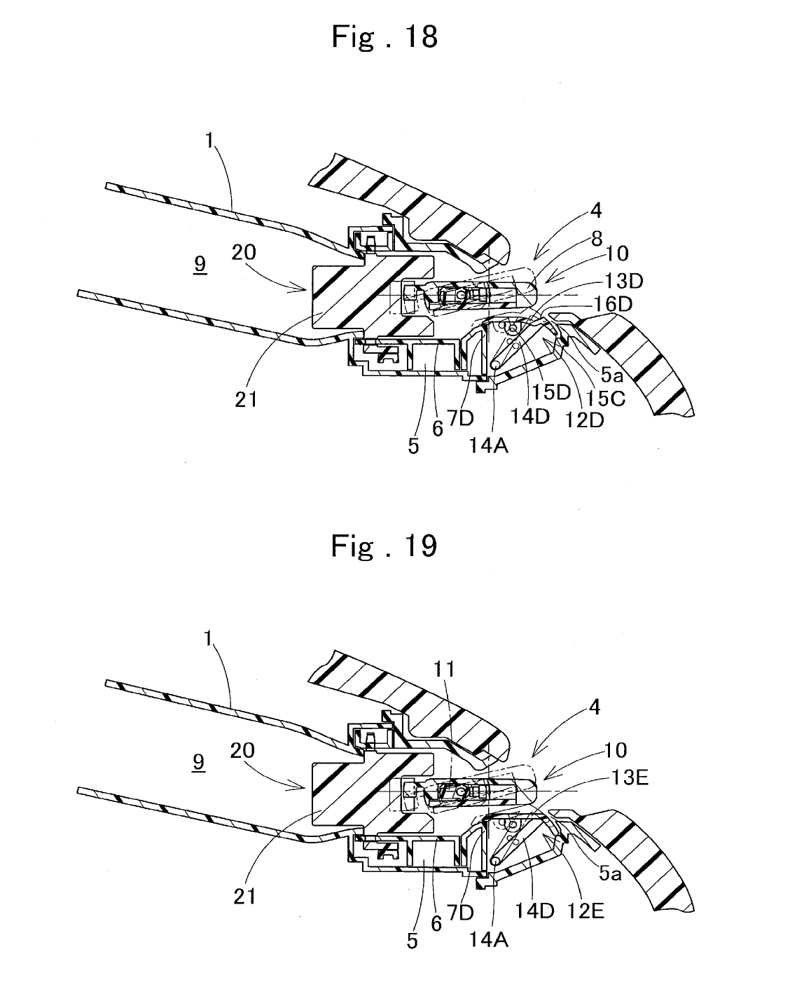

In addition, the above-described auxiliary fin may be, as shown in FIG. 19, provided as an auxiliary fin 12E having a flat fin main body 13E with no inclined surface provided. In this case, when the front movable louver 10 is turned up, as shown by the virtual lines in FIG. 19, the auxiliary fin 12E turns to the upstream side, its fin main body 13E inclines, and an inclined surface is produced on its upper surface. The inclined surface on the upper surface of the fin main body 13E is oriented to the lower surface side of the front fin 11 in an inclined manner. An air flow flowing under the front fin 11 thereby hits against the inclined surface on the upper surface of the fin main body 13E to be bent upward, that is, to the lower surface side of the front fin 11.

The air flow flowing under the front fin 11 is thereby, similar to the above, satisfactorily bent to the upside, so that air blowing from the air outlet 4 is blown with satisfactory directionality, obliquely upward in which the front fin 11 is oriented. Also, the opening 5a of the recessed portion 5 is covered at this time with the fin main body 13E of the auxiliary fin 12E not to be exposed, and even when peeping into the inside of the air outlet 4, only the surface of the fin main body 13E is visible, which does not cause deterioration in appearance.

Although a description has been given in the above-described embodiment of a thin register in a slanted shape for which the air outlet of the register main body is formed, in terms of its front shape, to incline so as to retract an upper portion to the upstream side and project a lower portion to the downstream side, the present invention can also be applied to a thin register having an air outlet close to a vertical plane, not in a slanted shape.

What is claimed is:

1. A thin register comprising:
a register main body having inside an air passage and having in a front portion an air outlet in a horizontally narrow and long shape; and
a front movable louver disposed, inside of the air outlet, so as to be able to be turned up or down, wherein
the air outlet is formed in a narrow and long shape by vertically narrowing a downstream-side end portion of the air passage,
in a bottom portion immediately inside of the air outlet of the register main body, a recessed portion is formed,
the front movable louver is composed of a front fin axially supported immediately inside of the air outlet and an auxiliary fin axially supported in the recessed portion under the front fin,
the front fin and the auxiliary fin are joined via a link member, and opposite end portions at an upstream side of the auxiliary fin are axially supported via pivots,
an inclined surface is provided on a distal end portion at a downstream side of the auxiliary fin,
a recessed portion cover to overlay the recessed portion is attached to the recessed portion, and an opening to project the distal end portion of the auxiliary fin therethrough is provided, in a vicinity of a downstream-side end portion of the recessed portion cover, along a longitudinal direction of the auxiliary fin, and
when the front movable louver is operated so as to turn to the upside, the auxiliary fin turns so as to project the distal end portion upward through the opening of the recessed portion cover and make the inclined surface of the distal end portion hit against an air flow flowing under the front fin.

2. The thin register according to claim 1, wherein the air outlet of the register main body is formed, in terms of its front shape, to incline so as to retract an upper portion to an upstream side and project a lower portion to a downstream side.

3. The thin register according to claim 1, wherein a recessed groove is longitudinally formed adjacently to the inclined surface of the auxiliary fin, the downstream-side end portion of the recessed portion cover is formed so as to be able to relatively enter into the recessed groove with a turn of the auxiliary fin, and at the time of a turning operation of the front movable louver, when the auxiliary fin turns so as to project the distal end portion into a passage, the downstream-side end portion of the recessed portion cover relatively enters into the recessed groove.

4. The thin register according to claim 1, wherein a rear movable louver is disposed on an upstream side of the front movable louver, and on an upstream side of the recessed portion cover, a bearing cover provided with a bearing portion to axially support a rear fin of the rear movable louver is disposed in a manner of covering an upstream side of the recessed portion.

5. The thin register according to claim 1, wherein the auxiliary fin is formed having a fin main body that covers substantially the whole of the opening, and is provided on opposite sides of the fin main body with pivots via lever portions.

6. The thin register according to claim 1, wherein the auxiliary fin is formed with a cover portion provided at front and/or rear of the fin main body so as to project therefrom, and constituted so as to cover the opening by the fin main body and the cover portion.

7. The thin register according to claim 1, wherein at a front surface of the air outlet of the register main body, an outer bezel is attached so as to cover an upper and lower part of the air outlet.
